(19) United States
(12) Patent Application Publication
(10) Pub. No.: US 2015/0332528 A1
(43) Pub. Date: Nov. 19, 2015

(54) System for Defense Weapon Control Utilizing One or a Plurality of Intelligent Weapons Control Boxes

(71) Applicants: Glenn McGinnis, Land O Lakes, FL (US); Scott McGinnis, Alpharetta, GA (US)

(72) Inventors: Glenn McGinnis, Land O Lakes, FL (US); Scott McGinnis, Alpharetta, GA (US)

(21) Appl. No.: 14/280,198

(22) Filed: May 16, 2014

(51) Int. Cl. G07C 9/00; E05G 1/02; E05G 1/10; F41C 33/06; E05B 65/00; E05G 1/04; A47B 81/00; E05G 1/00; E05B 47/00

(52) U.S. Cl. CPC G07C 9/00158; E05G 1/005; E05G 1/02; E05G 1/10; E05B 47/00; E05B 65/0075; E05G 1/04; A47B 81/005; F41C 33/06; E05B 2047/0072; E05B 2047/0048

(57) ABSTRACT

A system for storing, monitoring, and releasing emergency defense weapons in a weapon-free environment is disclosed. The weapons can quickly be accessed when they are required for defensive purposes.

### CROSS-REFERENCE TO RELATED APPLICATIONS

This application claims priority to Provisional Application No. 61/884,059 filed on Sep. 29, 2013, the entire contents of which are hereby incorporated by reference.

### FIELD OF THE INVENTION

This invention provides a secure solution to store, monitor and release emergency defense weapons stored in weapon free environments when they are required for defensive purposes.

### DESCRIPTION OF RELATED ART

Many types of venues where large numbers of people gather are designated as weapon free areas. Under this definition, attendees may not possess any type of firearm under any circumstance. Exceptions are granted for law enforcement personnel or certified personnel who may carry a weapon in an open or concealed fashion.

This invention provides a secure solution to store, monitor and release emergency defense weapons stored in weapon free environments when they are required for defensive purposes.

Gun free areas include but are not limited to schools, shopping centers, military bases in non combat zones, hospitals, places of worship, commercial establishments, meetings and other gatherings.

Gun free areas are intended to ensure maximum safety for all occupants as it is the primary intent to ensure that no individual/s can inflict harm on another with a firearm.

However, the inherent free will of mankind almost certainly guarantees that at some time, at unauthorized individual or individuals will illegally bring a weapon into a gun free environment with the intent of inflicting harm on one or more individuals. An illegal arms bearer has a tremendous advantage over the law abiding majority who are unarmed. Practicality dictates that law enforcement cannot guarantee the rapid response necessary to quickly mitigate the gunman's advantage. Likewise the cost of maintaining a private force that can provide adequate protection can be quite high. The dilemma when violent attacks occur in high population gun free areas is how to you maintain a gun free state for all occupants yet maintain quick response capability to stop the violence as soon as possible to prevent or minimize the loss of lives.

An additional supportive argument for establishing gun free zones is that if weapon bearers are allowed in the zone their weapon can be forcefully taken from them and used by an intruder.

It must be pointed out that the gun free environment also grants the tactical advantage to those desiring to inflict harm with other weapons such as knives, swords or other such forms of weapons.

In the greatest majority of times, the concept of a gun free zone succeeds in averting catastrophic violence. However, the very nature of a gun free zone establishes extreme vulnerability to those present when those rare violations occur. The attacking weapon bearer is almost invulnerable and can commit extreme damage to an unarmed populace until such time as someone with adequate firepower can stop the attack. The time the attacker has can range from seconds to hours depending upon the method of attack and if hostages are taken. The amount of damage done often depends upon the reaction time before the situation can be brought under control. It is imperative to minimize the response time for these situations. Today, there exists no practical methodology to ensure a quick and dependable reaction time.

### SUMMARY OF THE INVENTION

The embodiments disclosed herein describes a means whereby quick access to weapons is granted to designated trained and qualified defenders when a threat arises and authority is granted for weapon access. The embodiments have a key objective of balancing the relationship between:
Ensuring the right person can quickly obtain a defensive weapon at the right time.
Ensuring no one can obtain or tamper with a defensive weapon at any other time.
Ensuring a cost effective solution with variables that allow various features and security levels as needed.

The embodiments describe the means to constantly monitor the state of each secured weapon and react to system failures or intrusion attempts.

Using the embodiments disclosed herein ensures that no defensive weapons are available for use by an authorized user until there is a recognized emergency situation.

The embodiments comprise at least an intelligent weapon box which can be utilized in a standalone mode or integrated into a system comprised of: a centralized control console, remotely secured weapon boxes, biometric access authorization for control and weapon access, weapon box monitoring and alerting, emergency power for weapon boxes and control console, internal networking between system elements and designated defenders, external network connectivity to designated personnel/organizations and application programming and data base system.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an overview of the Integrated Intelligent Security System.

FIG. 2 is a frontal view of a single weapon gun box embodiment.

FIG. 3 is a frontal view of the embodiment of FIG. 2 with open access door.

FIG. 4 is a frontal view of the embodiment of FIG. 2 with safety cover in place.

FIG. 5 is a frontal view of the embodiment of FIG. 2 with the weapon cover open.

FIG. 6 is a frontal view of the embodiment of FIG. 2 with safety covers in place.

FIG. 7 is a perspective view of the embodiment of the in wall single weapon gun box.

FIG. 8A is a perspective view of the embodiment in FIG. 7.

FIG. 8B is a access cover door lock details of the embodiment in FIG. 8A.

FIG. 9 is a another view of the embodiment in FIG. 7.

FIG. 10 is a perspective view of a single door embodiment.

FIG. 11 is a interior view of the single door embodiment of FIG. 10.

FIG. 12 is a interior view of an additional embodiment.

FIG. 13 is a interior view of an embodiment of a Standalone Intelligent Weapon Box.

FIG. 14 is a depiction of yet another embodiment of the Intelligent Weapon Box.

### DETAILED DESCRIPTION OF THE PREFERRED EMBODIMENTS

The embodiments disclosed herein propose to make defensive weapons available to authorized and qualified personnel who are skilled in the use of said weapons to terminate fatal attacks and acts of terrorism that can be inflicted by persons unlawfully bringing arms into soft targets. A soft target environment is one in which multitudes of personnel are in close proximity in gun free zones. The proposed embodiments must monitor and control:
the location, state of readiness and access attempts for each weapon it controls
the authorized weapon users who are present in the campus
authorized removal of a weapon, who removed it and when it was removed
maintenance information for the weapon box infrastructure including information such as electrical power interruption to any weapon box
the operational status of vital external communication links to notify external responders
location of gun fire within the campus if the campus is equipped with acoustic gunfire detection capabilities

It must be identified that security systems do exist for the control of weapons stored in designated armory facilities. However, these do not provide rapid response to the emergency scene as is contemplated within this specification, as the earlier security systems are typically housed in law enforcement or military facilities and are remote responder weapons.

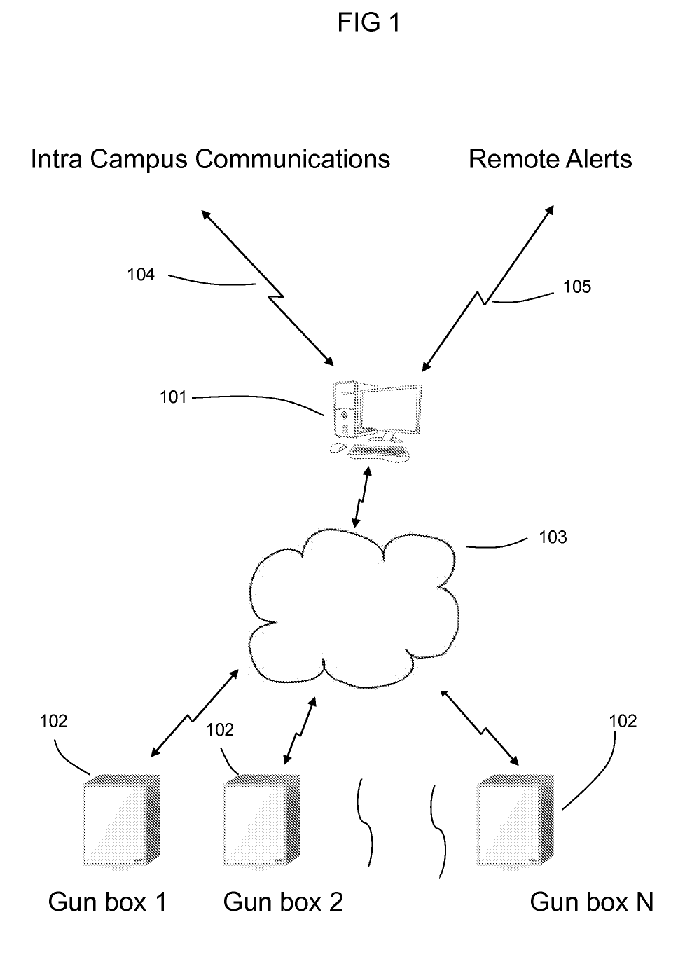

### FIG. 1 Integrated Intelligent Security System Component Description

A programmable control computer and operating system 101 hereinafter referred to as control system 101 are necessary to operate one or more intelligent weapon boxes and implement all of the benefits and features available. Most benefits of the art are also available by using a standalone version of the intelligent weapon box.

The control system 101 is connected to all components of the Multi Tiered Security System described herein to provide functions including: monitoring the readiness and physical security of all boxes, maintaining and monitoring connection to external responders, broadcasting appropriate security information to defenders and other personnel on campus, recording and validating or rejecting all attempts to access a weapon box, and maintaining all relevant data necessary for system operation.

One or a plurality of weapon boxes 102 is utilized with the system 101. The weapon boxes 102 can be manufactured in any size or shape required. A suitable weapon box must be manufactured with sufficient strength to ensure it is highly resistant to breaking and entering. It may contain a weapon or a plurality of weapons. Other items that may assist a defender such as tear gas spray, extra ammunition or a flashlight may also be contained in the weapon box if so desired.

A control network 103 provides connectivity and communications between the control computer 101 and all weapon boxes 102. An intra campus communications network 104 is optional and allows the control computer 101 to provide all system functions across multiple buildings and or geographic locations. The intent was to say that the system can send various types of alerts 105 and status messages to remote locations such as law enforcement or other designated recipients. These can include system problems such as a weapon box not responding and requiring a service event to be scheduled.

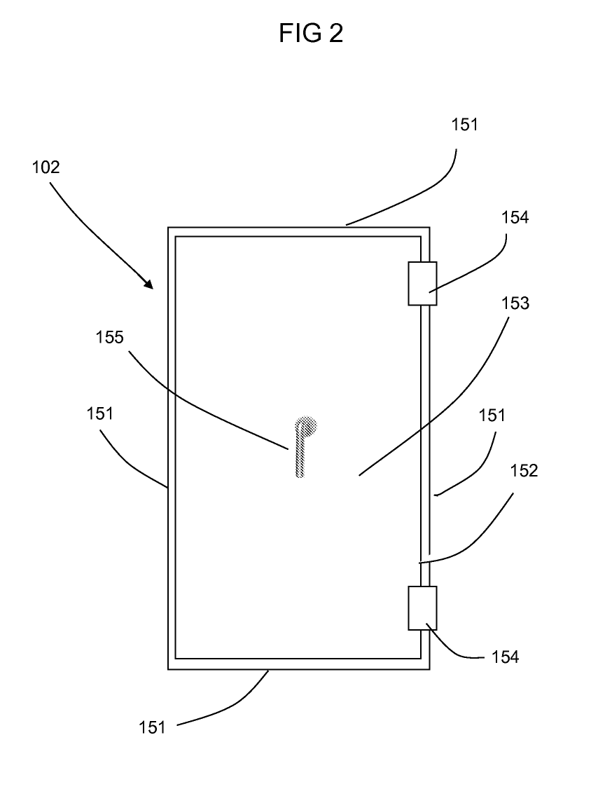

### FIG. 2: Frontal View of a Single Weapon Gun Box Embodiment

The overall design requirements for a weapon box 102 can be defined by variables such as type of weapon to be stored, the number of weapons to be stored, additional storage requirements, allowable room for installation, installation site environment, the amount of security required and cost.

Within the embodiments disclosed herein, all mechanical fasteners used to anchor the box to a building structure must be inaccessible from the exterior of the box. If not, no worries. Weapon boxes 102 may be installed at any location where it can be permanently installed. The weapon boxes 102 may be installed in locations where they are visible and apparent to occupants. This is may be appropriate if the presence of the Intelligent Weapon Box System is made known to all and used as a deterrent. Alternatively, the weapon boxes 102 may be installed such that they are hidden from sight to conceal where weapons are located.

Careful consideration and planning for a weapon box 102 must be performed prior to installation to ensure maximum security for the weapons and maximum operational readiness of the entire system.

All outer stationary structure members including sides, bottom, top and back of the weapon box 102 must be steel or an equivalent material providing sufficient strength to ensure it is highly resistant to breaking and entering. It must have a main access opening 152 that can be secured with an access cover door 153. The access cover door 153 is attached to one side of the weapon box 102 by use of two or more hinge mechanisms 154. The hinge mechanisms 154 are to be welded to the weapon box surface 151 and the hinge pins are to be covered to ensure they can not be removed or breached with tools. A lock handle 155 that can be rotated 90 degrees will allow a weapon box user to open the access cover door 153 if the control computer 101 has sent an unlock access cover door 153 command to the specific weapon box being accessed. A user can close and lock the access cover door 153 by closing the door and turning the lock handle 155 for example 90 degrees. Once the door is closed and locked it may not be opened until such time as another unlock access door 153 has been received from the control system 101.

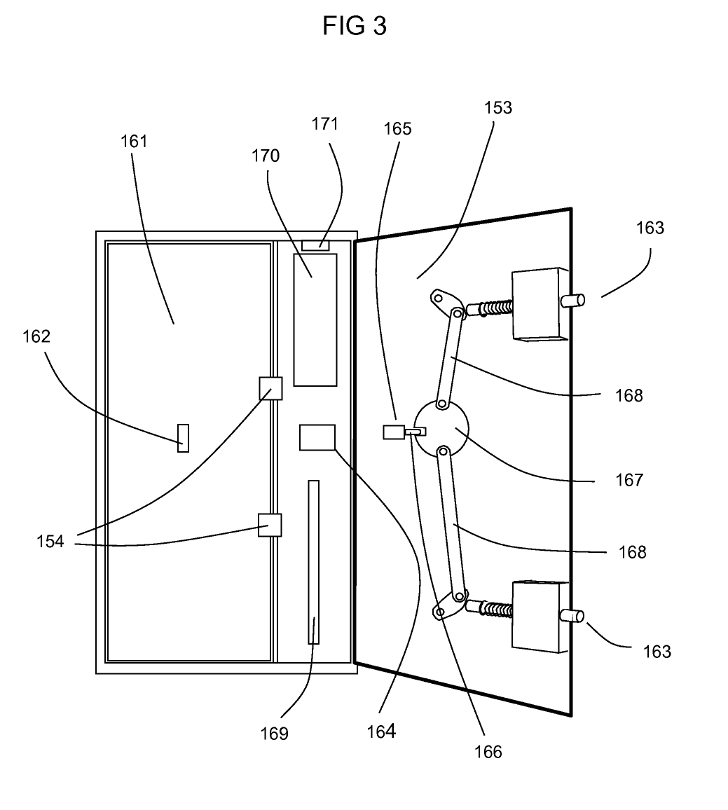

### FIG. 3 Frontal View of the Embodiment of FIG. 2 with Open Access Door

After the control computer 101 sends an unlock weapon box command via the control network 103 to the weapon box controller 164, it then decodes the command and energizes the access cover solenoid 165 via the internal weapon box electrical system. The access cover solenoid 165 then retracts the access cover lock pawl 166 which then allows the access cover unlock wheel 167 to rotate when the user turns the lock handle 155. The unlock wheel 167 then moves the lock link assemblies 168 to retract the lock pins 163 toward the hinge side of the access cover door 153 to unlock the access cover door.

The weapon box controller 164 performs all communications functions to and from the control computer 101 via the control network 103. Functions performed by the controller comprise but are not limited to: recognizing the logical address of the weapon box, receiving and decoding commands from the control computer 101 such as but not limited to: unlock access cover door 153, unlock weapon cover door 161, read biometric scanner 162, lock access cover door 153, lock weapon cover door 161, check lock status, check for weapon in box indication 171 toggle power to humidifier 169, check weapon box 102 humidity and temperature and request weapon box status information. The weapon box controller 164 contains sensors that monitor weapon box 102 temperature, lock status, humidity, communication interface 103 and biometric scanner 162 operational status. An audio communications jack is provided to allow optional voice communications between a user at the weapon box and users at other weapon boxes or a situation manager who granted access to the box.

A dehumidifier 169 can be used to keep moisture out of the weapon box 102. The dehumidifier is an electrical heater that keeps the interior of the weapon box 102 three or four degrees warmer than the ambient air. The dehumidifier 169 is electrically powered and can be turned on and off based on the humidity readings of the weapon box 102. Keeping the moisture level low will help the reliability of any stored weapon by reducing rust and keeping the ammunition dry.

A power module 170 is also present in the weapon box 102. The power module provides multiple functions. The power module 170 receives incoming electrical power from the buildings electrical system and use the power to: maintain the charge level of a backup battery in the power module. The power module 170 also supplies all low voltage power necessary to operate the weapon box controller 164, the biometric scanner 162 and other accessories that may be added to the weapon box 102.

It is extremely important that all possible measures be employed to ensure that a weapon secured in the weapon box 102 is not stolen or tampered with. To that end, almost all weapon box maintenance can be performed with only the access cover door 153 unlocked. Maintenance people could resolve problems or inspect all elements of the access cover door 153, the dehumidifier 169, weapon box controller 164 and power module 170 as well as power and communications interface cables. A special service mode can be assigned to a weapon box 102 that will ensure the biometric scanner 162 is completely disabled prior to the service event. This entire system will be serviced in much the same fashion that automated teller equipment is serviced whereby as much physical separation of machine and cash is maintained. Similarly, the objective in these embodiments is to keep as much separation between the equipment being serviced and the secured weapon. When the access cover door 153 is open the LED interior light 171 is automatically illuminated. The characteristics and requirements mentioned in this paragraph apply to any and all embodiments of weapon box that may arise.

The control computer 101 always monitors the state of all connected weapon boxes 102, power losses, communications interfaces, internal environmental specifics, door status and weapon security.

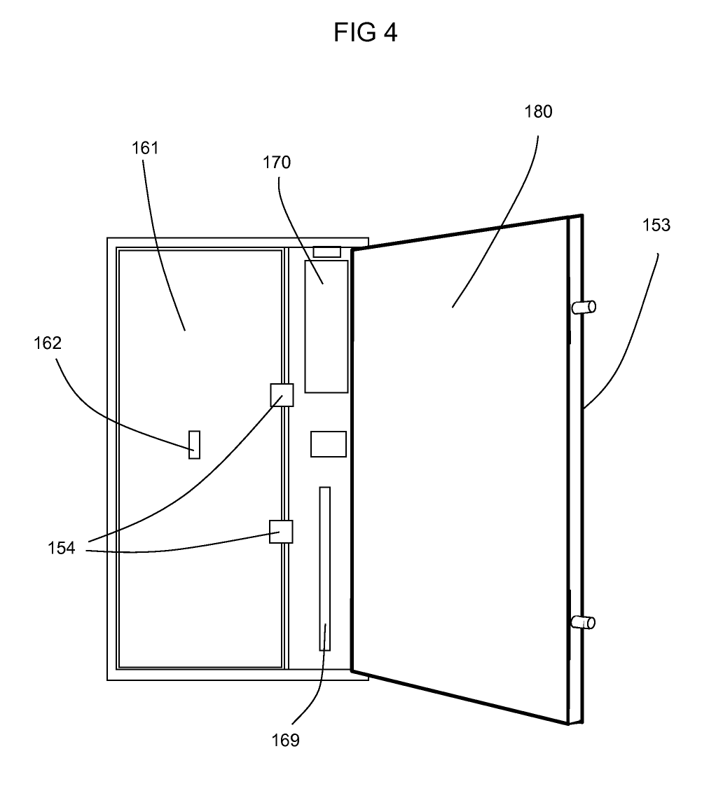

### FIG. 4: Frontal View of the Embodiment of FIG. 2 with Safety Cover in Place

The access cover door safety over 180 is used to cover and protect all of the door locking mechanisms. The reasons this embodiment uses two layers of locked covers is to better ensure the maximum security of the contents of the weapon box 102, permit most service and maintenance activities to be performed with the weapon still secured and out of sight, protect the biometric scanner 162 from sabotage, and still maintain the capability for an authorized user to obtain a fully serviced and loaded defensive weapon within seconds.

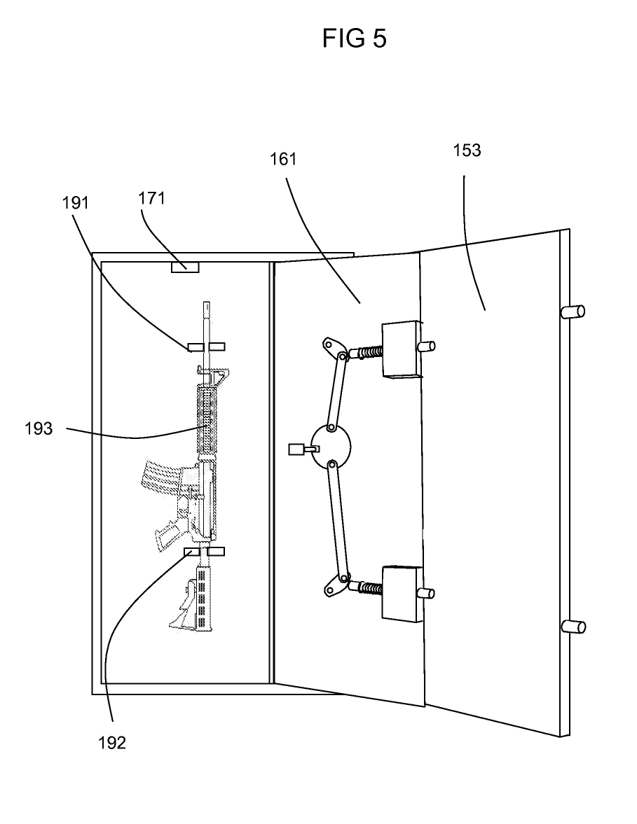

### FIG. 5: Frontal View of the Embodiment of FIG. 2 with the Gun Cover Open

The user must initiate open weapon cover door 161 process by performing a biometric scan via the biometric scanner 162. The control system 101 then performs a requester authorization to ensure that the person attempting to open the weapon cover door is entitled to use the enclosed weapon. If rejected, the user can retry the process the number of time specified by the system. After the control computer 101 sends an unlock weapon cover door 161 command via the control network 103 to the weapon box controller 164 it then decodes the command and energizes the access cover solenoid 165 via the internal weapon box electrical system. The access cover solenoid 165 then retracts the access cover lock pawl 166 which then allows the access cover unlock wheel 167 to rotate when the user turns the lock handle 155. The unlock wheel 167 then moves the lock link assemblies 168 to retract the lock pins toward the hinge side of the access cover door 153 to unlock the access cover door. When the access cover door 153 and the weapon cover door 161 are both open the weapon is exposed to view and available to the user. The upper weapon holder 191 and lower weapon holder 192 are both equipped with pressure sensor that will detect weapon motion. The detected weapon movement will be sent as a notification to the control computer 101. When the weapon cover door 161 is open the LED interior light 171 is automatically illuminated.

If the control computer 101 has previously sent an unlock cover access door 153 command within a user defined period of time and a biometric scanner 162 generated open weapon cover door 161 request has been received by an authorized and validated user a weapon removed alert will be generated and predefined notifications will be dispatched to predefined persons via the control computer 101 monitor and communications links accessible to the control computer 101.

If a weapon removal has been sensed without the required prerequisite commands a high priority system alarm will be generated.

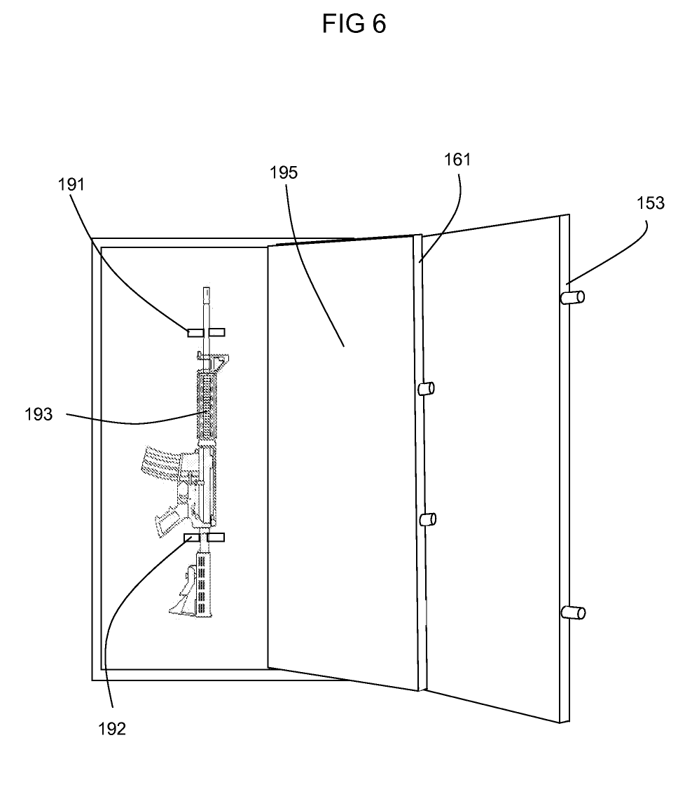

### FIG. 6 Frontal View of the Embodiment of FIG. 2 with Safety Covers in Place

This drawing represents how the open weapon box 102 will appear when all safety covers are in place and the control computer 101 has issued both door unlock commands. When the user removes the weapon a “weapon removed” status will be sent from the weapon box 102 to the control computer.

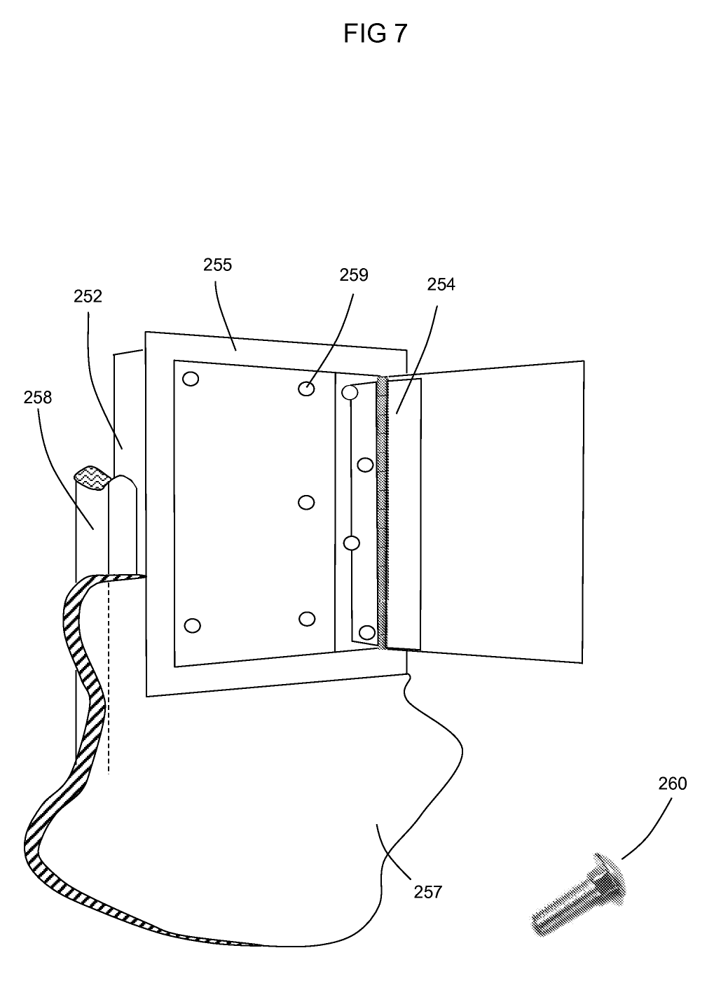

### FIG. 7: Perspective View of the Embodiment of the in Wall Single Weapon Gun Box

Hiding a defensive weapon concealed within a weapon box 201 embedded within a wall 202 is a preferred method to ensure that the weapon can be stored near potential weapon users while remaining well secured. Walls vary in thickness and range from mostly hollow walls with support studs to solid masonry wall construction.

This embodiment represents art that will fit within the confines of a wall with 16″ stud centers and a depth of 3.5 inches. Some weapons will not fit in this embodiment but most will.

This embodiment of a weapon box 252 uses a bezel 255 to make it supportive of flush mounting on a wall surface 257. The embodiment has a width that is intentionally structured to permits fitting between standard 16 inch centered wall studs 258. The width and depth can be altered to coincide with any wall stud spacing and depth. In addition it can be manufactured in any size opening of a solid wall. Knock out holes 259 are punched into the box 252 sides, top, bottom and back for mounting purposes. Hole plugs 260 are supplied for security purposes. If any knock out holes 259 are exposed after installation it is advised that the installer remove the plugs and insert the supplied knock out hole plugs 260.

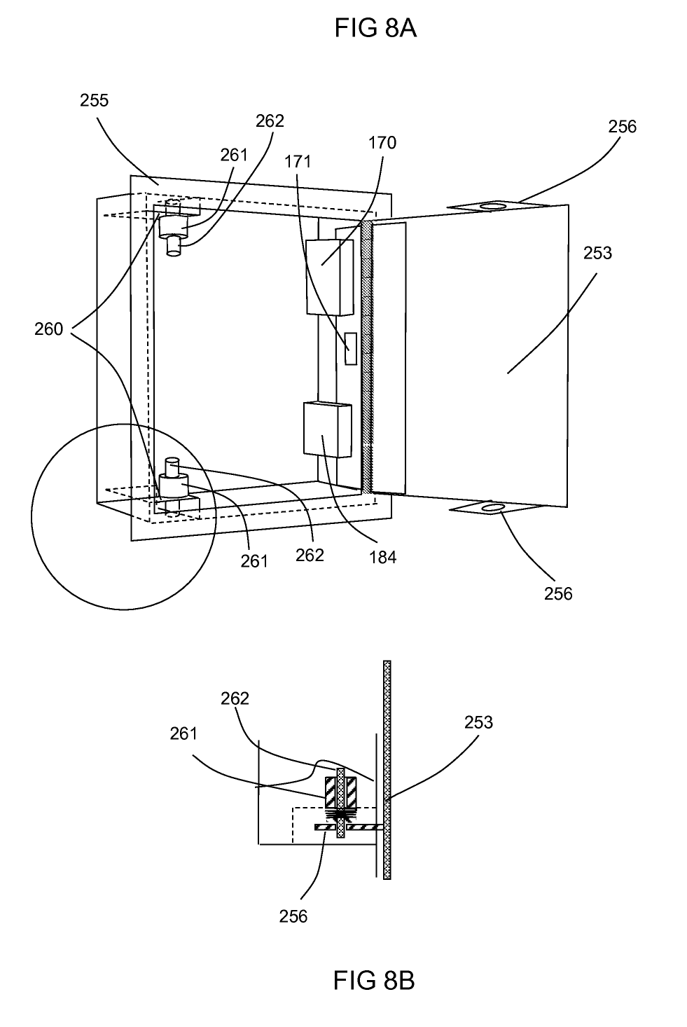

### FIG. 8A: A More Detailed Perspective View of the Embodiment in FIG. 7

This embodiment of weapon box 252 is small because of the limited space requirements it requires. However, the product functionality is the same as any other weapon box embodiment described herein. The access cover door 253 is equipped with two access cover door plates 256 that will fit between the bezel 255 and the access cover door solenoid base plate 260 when the access cover door 253 is closed. Please refer to FIG. 8A for more detail regarding how the access cover door 253 is secured in the closed position.

When the weapon box 252 is secured the access cover door 253 is secured and no access to the interior of the weapon box 252 is granted. The cover access door is unlocked by a control computer 101 sent unlock weapon box command sent via the control network 103 to the weapon box controller 164. The controller then decodes the command and energizes both access cover door solenoids 261 such that the cover door solenoid shafts are moved toward the interior of the weapon box. The door can then be opened and the LED interior access light 171 will automatically provide illumination.

The weapon box controller 164 is logically the same unit used in all weapon box embodiments and as such, performs all communications functions to and from the Control computer 101 via the control network 103. Functions performed by the controller include: recognizing the logical address of the weapon box, receiving and decoding commands from the control computer 101 such as but not limited to: unlock access cover door 253, unlock weapon cover door 265, read biometric scanner 266, lock access cover door 253, lock weapon cover door 266, check lock status, check for weapon in box indication 171, check weapon box 102 humidity and temperature and request weapon box status information. The weapon box controller 164 contains sensors that monitor weapon box 252 temperature, lock status, humidity, communication interface 103 and biometric scanner 162 operational status. An audio communications jack is provided to allow optional voice communications between a user at the weapon box and the situation control point.

Due to the reduced interior volume, this embodiment of FIG. 8A cannot contain a dehumidifier. This embodiment can be increased in size to accommodate a dehumidifier if required.

A power module 170 is also present in the weapon box 255. The power module provides multiple functions. The power module 170 receives incoming electrical power from the buildings electrical system and uses the power to maintain the charge level of a backup battery in the power module. It also supplies all low voltage power necessary to operate the weapon box controller 184, the biometric scanner 162 and other accessories that may be added to the weapon box 255.

### FIG. 8B: Access Cover Door Lock Details of the Embodiment in FIG. 8A

The locking described herein is one of a multitude of lock types that can be used for the in the wall embodiment of the weapon box 255.

When the control computer 101 sends an unlock access cover door 253 command the two access cover door solenoids 261 are electrically energized and the two access cover door lock pins 262 are driven away from the 2 access cover door plates 256 which in turn causes the access cover door lock pins to be moved such that they are extracted from the opening in the access cover door plates and the access cover door 253 can now be opened outward.

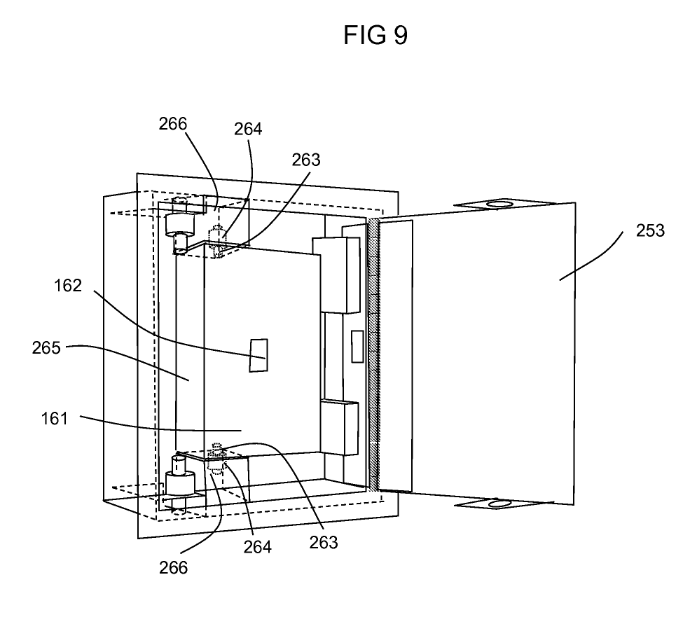

### FIG. 9: Another View of the Embodiment in FIG. 7

Upon gaining access via the opened access cover door 253 an authorized user can then operate the biometric reader 162 and the open weapon cover door command will be generated and sent to the control computer 101 for user authentication. If the user is authorized then an open weapon cover 161 command will be generated and sent to the weapon box 255 and the weapon box controller 184 will cause the weapon cover 161 to be released by energizing the two weapon box solenoid coils 264 which in turn cause the weapon box lock pins 263 to be withdrawn from the weapon box 265. The weapon box solenoid coils 264 and the weapon box lock pins 264 are enclosed in and protected by the weapon box lock protectors 266. The weapon box lock protectors 266 ensure that an unauthorized person ma not open the weapon box 265.

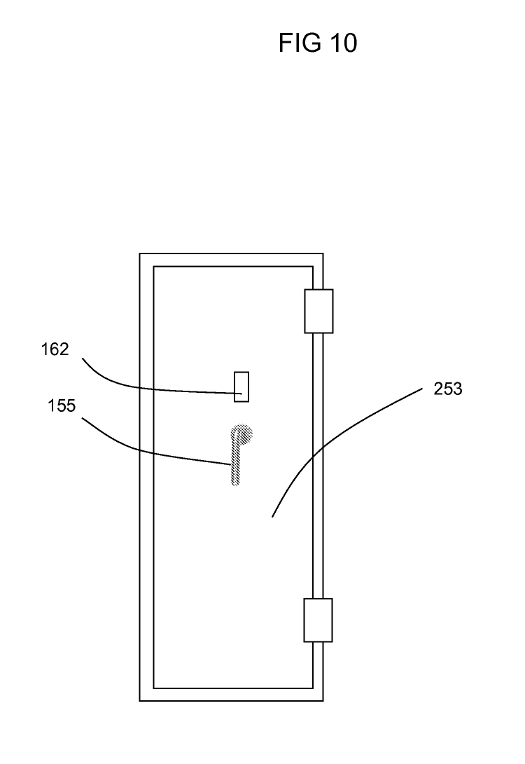

### FIG. 10: Perspective View of a Single Door Embodiment

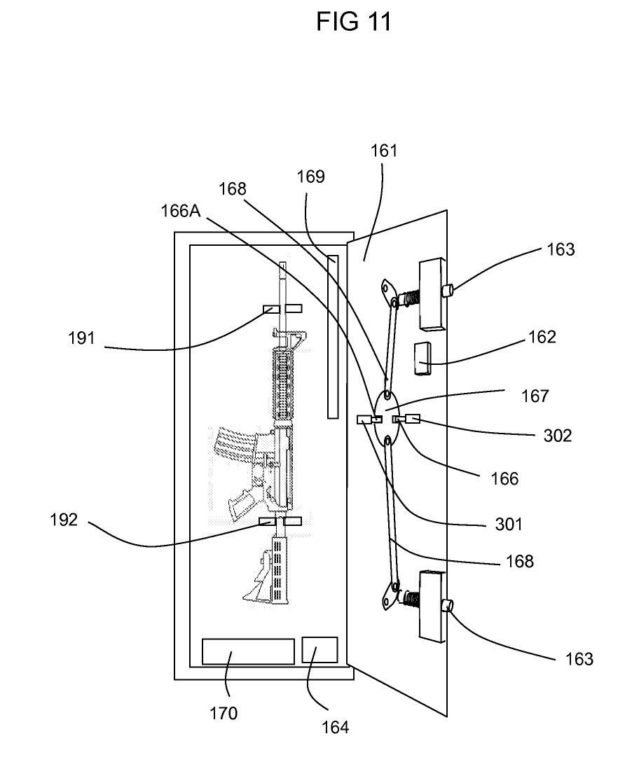

This embodiment provides the same functions as other embodiments with two notable exceptions. It will be illustrated in FIG. 11 that this product does not have an inner cover panel that is used to cover the weapon. Thus, when a user gains access via the front cover they will have immediate access to the enclosed weapon. The embodiment does have multiple layers of security in that a biometric reader 162 is installed on the face of the access cover door 253.

This embodiment is lower in cost over the previous embodiments because the cost of the weapon door and locking hardware is removed. It does however have one disadvantage that does not exist on embodiments featuring both an outer access cover that is system actuated and in inner door that contains the biometric reader. The biometric reader when placed inside the access cover door 253 is immune to vandalism and sabotage. However, this exposure can be mitigated if the weapon box is mounted in a tightly secured area and/or is hidden from view by a picture or some other fashion of cover.

### FIG. 11: Interior View of the Single Door Embodiment of FIG. 10

After the control computer 101 sends an unlock weapon box access door command via the control network 103 to the weapon box controller 164 it then decodes the command and energizes the computer controlled access cover solenoid 301 via the internal weapon box electrical system. The access cover solenoid 301 then retracts one of the access cover lock pawls 166. Note the access cover unlock wheel 167 has two locking pawls 166 and 166A. One locking pawl 166 is controlled by the control computer and is unlocked when an unlock access cover door command is received. The second locking pawl 166A is controlled by the control computer when it issues an open weapon cover door command. This command is generated as a result of the unlock weapon box access door command and the successful biometric reader 162 generation of input received from an authorized user.

Once both pawls are retracted the access cover unlock wheel 167 is allowed to rotate 167 when the user turns the lock handle 155. The unlock wheel 167 then moves the lock link assemblies 168 to retract the lock pins 163 toward the hinge side of the access cover door 153 to unlock the access cover door 161.

A dehumidifier 169 can be used to keep moisture out of the weapon box 102. The dehumidifier is an electrical heater that keeps the interior of the weapon box 102 three or four degrees warmer than the ambient air. The dehumidifier 169 is electrically powered and can be turned on and off based on the humidity readings of the weapon box 102. Keeping the moisture level low will help the reliability of any stored weapon by reducing rust and keeping the ammunition dry.

A power module 170 is also present in the weapon box 102. The power module provides multiple functions. The power module 170 receives incoming electrical power from the buildings electrical system and uses the power to: maintain the charge level of a backup battery in the power module. It also supplies all low voltage power necessary to operate the weapon box controller 164, the biometric scanner 162 and other accessories that may be added to the weapon box 102.

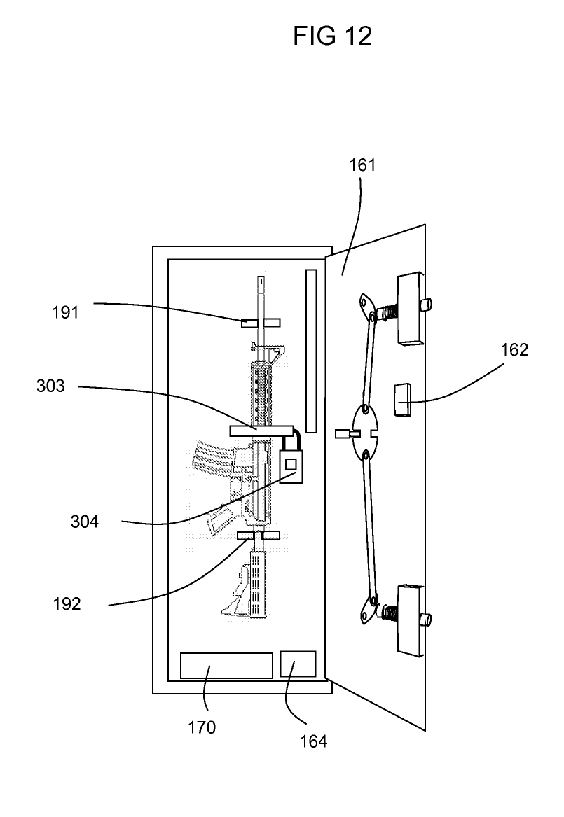

### FIG. 12: Interior View of an Additional Embodiment

This embodiment differs from the embodiment described in FIGS. 10 and 11 in the following respects.
It does not have a biometric reader on the access cover door 161.
It does have an interior weapon lock 303 positioned such that it can be used to mechanically position the weapon into the upper weapon rack 191 and the lower weapon rack 192.
Additionally a biometric head lock 304 is used to lock the interior weapon lock 303.

All other aspects of operation are the same with the exception that the control computer 101 will not issue an unlock weapon cover command. This configuration permits an authorized biometrically identified individual to remove the weapon after the box has been unlocked with the issuance of an unlock access cover door command.

When the weapon is removed the upper weapon rack 191 and the lower weapon rack 192 will sense and report the removal of the weapon to the control computer.

The use of the interior weapon lock 303 and the biometric headlock 304 is an available option that may be added to any embodiment and will then present a third level of protection.

It is very highly recommended that all weapon boxes be video monitored on a full time basis. An internal video camera may be added to any embodiment and the camera can serve as a security monitor on a full time basis. This camera can also be used as a facial recognition monitor and deny access to any individual whose face is not recognized as an authorized user by the control computer.

The following embodiment if this art is a stand alone implementation of any of the embodiments documented by this statement of the art.

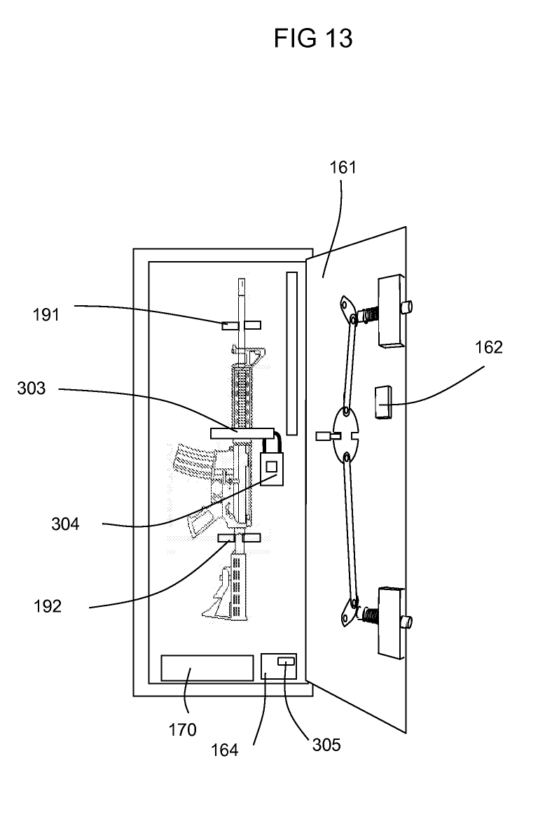

### FIG. 13: Interior View of an Embodiment of a Standalone Intelligent Weapon Box

A standalone intelligent weapon box can be used without an externally connected control computer. This embodiment can be used in locations that have a single or a multitude of weapon boxes.

Both the standalone and system controlled weapon box embodiments use the same weapon box controller 164.

Some of the functionality normally resident within a control computer is relocated within the cover lines of the weapon box by using an enhanced weapons box controller consisting of additional circuitry included within the weapon controller 164.

The enhanced weapon box computer is tightly, electronically coupled to the weapon box computer and performs as the master of the two connected computers.

All events recognized by the weapons box computer are passed to the enhanced weapon box computer. The enhanced computer can record these events which are time stamped. The accumulated events can be transmitted to a networked computer as well as retrieved by a portable device such as a “smart phone, portable computer, specialized test box or other device connected to the weapon box data acquisition and control port 305 or wireless connectivity.

Events can be categorized by priority. Emergency events such as “weapon box opened by an authorized user” would be a category 1 event. Likewise a loss of electrical power to the box would typically be an intervention required event as the weapon box is able to switch to its' internal emergency power source. An external visual or audio signal may also be used to signal for attention to intervention required types of events.

The security protocol for a standalone intelligent weapon box differ from that of a control computer connected intelligent weapon box as all levels of access must be requested and granted by a user who has physical access to the weapon box. Ideally at least two levels of access would be retained by the use of an externally accessed biometric reader and an additional biometric head lock 304 used to lock the interior weapon lock 303. The two layer physical weapon box security should be enhanced with site security including but not limited to: Locating the weapon box in a secure and locked room, maintaining video monitoring and not disclosing the presence or location of a weapon box.

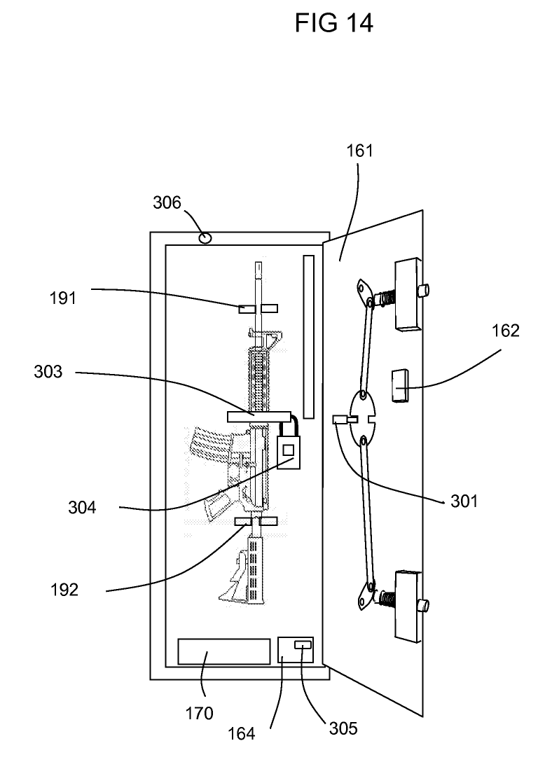

### FIG 14: Depiction of Yet Another Embodiment

This embodiment differs from the others in that the layer of security provided by the control computer 101 is realized by issuing power up and power down commands to the weapon box controller 164. The power up command causes operational voltage to be applied to the biometric scanner 162. When power is applied to the biometric scanner 162 a Light Emitting Diode 306 will be energized and indicate that biometric scanner 162 is ready for use. When an authorized user swipes the reader the fingerprint file is sent to the control computer for authentication. If the print is authenticated the reader will receive the instruction to energize the access cover lock solenoid 301.

The control computer 101 will continually be updated by status items such as weapon box status, door open, weapon removed and other pertinent data necessary to ensure complete remote command and control of the box.

The common user authentication device reference throughout the description for this invention is a biometric fingerprint lock. The specific type of biometric scanner can be either a stationary print reader or a sliding print reader. There are other types of biometric authentication methods in use such as retinal scanners, palm print scanners, voice recognition and facial recognition to name a few. Any existing biometric authentication device or any anticipated such devices can be utilized on all embodiments of the invention. In addition other non-biometric electronic methods such as sequence sensitive key pads, combination locks, conventional keys or other forms of locking mechanisms may be used.

What is claimed is:

1. A secure weapons box comprising:
an outer enclosure adapted to be securely fixable to a wall or other permanent surface;
a locking mechanism non-removably affixed to the outer enclosure;
a reconfigurable biometric sensor operably attached to the locking mechanism; and
an internal computerized controller that enables and disables the biometric sensor.

2. The box of claim 1, further comprising:
an outer enclosure adapted to be securely fixable to a wall or other permanent surface;
a locking mechanism non-removably affixed to the outer enclosure;
a reconfigurable biometric sensor operably attached to the locking mechanism; and
an internal computerized controller that enables and disables a second locking mechanism non-removably affixed to the outer enclosure.

3. The box of claim 1, further comprising:
the box is configured to contain a single weapon, and
a reconfigurable biometric sensor is configured to only open/activate for a single person.

4. The box of claim 1, further comprising:
the box is configured to contain a single weapon, and
reconfigurable biometric sensor is configured to only open/activate for a discrete, known set of multiple persons.

5. The box of claim 1, further comprising:
the box is configured to contain multiple weapons.

6. The box of claim 1, further comprising:
the box is configured to be contained within a wall, or other suitable opening; and
the box may be concealed from view.

7. The box of claim 1, further comprising:
the box contains a dehumidifier; and a temperature control mechanism.

8. The box of claim 1, further comprising:
a backup battery is contained within the box; and
a battery charging mechanism is contained within the box.

9. The box of claim 1, further comprising:
communications facilities to other boxes and the central control point, located within the box; and
interior illumination is included within the box.

10. The box of claim 1, further comprising:
a plurality of sensors which communicate events comprising:
biometric sensor operation;
door opening;
weapon removal; and
internal equipment failures within the box.

11. The box of claim 1, further comprising:
an internal lock which retains one or more weapons within the box and provides an additional level of security.

12. The box of claim 1, further comprising:
any other fashion of human operable locking device is operably attached to the locking mechanism.

13. The box of claim 1, further comprising;
a control computer, in communication with a control network, for managing operation, maintenance and servicing of the box; and
a computer application performing automated managing, alerting, maintaining, and tracking of activity within or relating to the box.

14. A method of securing a facility occupied by humans, comprising;
positioning as secure weapons box within the facility;
populating the secure weapons box with one or more weapons;
configuring the secure weapons box to only be openable by a discrete, limited group of individuals whose access will be verified biometrically, under control of a computerized system accessible only by personnel responsible for managing crisis situations.

15. The method of claim 14, wherein the steps of configuring further comprises;
operating and maintaining a control computer to manage communications with a control and communications network, such that the control computer interfaces directly with the biometric identifier and all other sensors within the weapons box.

16. The method of claim 15, further comprising;
updating the control computer with new biometric and personnel data as individuals are added, removed, transferred and receive training updates.

17. The box of claim 16, wherein the step of updating the control computer and the in box computer is executed remotely through the control network.

18. The box of claim 15, wherein;
all communications occur using a proprietary security protocol or encryption.

19. The box of claim 15, wherein;
inter systems networks are utilized to perform alarm and notification functions.

20. The box of claim 15, wherein;
automated monitoring is performed on all elements of the weapon boxes, networks and control computer;
response scripts used to prevent unattended management of the system.
